(19) United States
(12) Patent Application Publication
(10) Pub. No.: US 2025/0332527 A1
(43) Pub. Date: Oct. 30, 2025

(54) Device for separating gas from a vector fluid in a circuit of a thermal system

(71) Applicant: CALEFFI S.p.A., Fontaneto d’Agogna (Novara) (IT)

(72) Inventor: Marco CALEFFI, Fontaneto d’Agogna (Novara) (IT)

(21) Appl. No.: 18/864,628

(22) PCT Filed: May 9, 2023
(86) PCT No.: PCT/IB2023/054794

§ 371 Date: Nov. 11, 2024

(30) Foreign Application Priority Data
May 12, 2022 (WO) PCT/IB2022/054420

(51) Int. Cl. B01D 19/00

(52) U.S. Cl. CPC B01D 19/0057

(57) ABSTRACT

A device for separating gas from a vector fluid in a circuit of a thermal system has internally a cylindrical chamber provided upperly with an inlet for the fluid which is offset with respect to the axis of the chamber and provided lowerly with an outlet for the fluid; in the upper part of the chamber a gas collecting tube is coaxially located which extends along the chamber and communicates upperly with an automatic gas vent valve; around the tube a swirling motion develops and inside the tube gas bubbles rise to the gas vent valve; near and upstream of the outlet in the chamber an intercepting disc is provided which is spaced away from the lower edge of the tube and prevents the central part of the fluid in swirling motion that forms between the edge of the tube and the disc to flow into the outlet area. The device allows all or almost all the amount of gas flowing in the circuit to be evacuated in a single passage and can be easily assembled.

### BACKGROUND OF THE INVENTION

The present invention relates to a device for separating gas from a vector fluid, intended to be used in a circuit of a thermal system.

### PRIOR ART

In a heating and/or cooling system, the heat is typically conveyed, through a hydraulic circuit, by a vector fluid. Inside the vector fluid (usually water), gas may however be present; the latter (typically air), in particular, can have various negative effects in terms of efficiency, noise, safety and durability of the components of a system.

It is often difficult to prevent the presence of gas inside the vector fluid, for example considering the water that commonly circulates inside a circuit of a thermal system, it often contains air inside, because the latter can derive not only from the air dissolved in the filling or topping up cold water but also from the air not expelled during the filling phase of the system. Further, it is possible that air enters even during the operation of the system itself.

For this reason, devices and/or constructional methods are used for evacuating gas inside these pipes. In particular, devices are known which allow the gas contained within a fluid flowing through a hydraulic circuit to be evacuated by placing the vector fluid itself in a swirling motion, for example, the device described in the French patent application FR2043048A5.

Patent application FR2043048A5 in fact describes a device for separating gas from a liquid which comprises two chambers, one lower and the other upper, partially separated by a dividing wall provided with a passage opening. The lower chamber, in particular, is provided with an inlet and an outlet for the liquid, arranged so that, also thanks to the shape of the lower chamber, the liquid generates a swirling motion inside the lower chamber itself. In this way, part of the gas separates from the liquid, forming gas bubbles which will accumulate in an area in the centre of the vortex. Lastly, the bubbles thus generated rise to the upper chamber, flowing through the passage opening, and reach an automatic vent valve which allow the gas bubbles to be evacuated.

However, at present, the devices for separating gas from a vector fluid are sized to evacuate only a part of the gas which flow through the piping, and, therefore, several passages through the device for separating gas are required before evacuating most of the gas.

It would therefore be desirable to improve the current devices for separating gas from a vector fluid to allow all or almost all the amount of gas flowing through a circuit of a thermal system to be evacuated in a single passage, while ensuring at the same time easy installation along the piping of a circuit of a thermal system.

### OBJECTS OF THE INVENTION

An object of the present invention is to propose a device for separating gas from a vector fluid which can evacuate all or almost all the amount of gas flowing through a circuit of a thermal system in a single passage.

A further object of the present invention is to provide a device for separating gas from a vector fluid which can be easily assembled with the piping of a circuit of a thermal system.

### BRIEF DESCRIPTION OF THE INVENTION

These objects are achieved by a device for separating gas from a vector fluid according to the first claim.

### BRIEF DESCRIPTION OF THE DRAWINGS

The invention will be better understood with reference to the attached drawings which illustrate an exemplifying and non-limiting embodiment thereof, in which:

FIG. 1 is a perspective view of a device for separating gas from a vector fluid according to the invention;

FIG. 2 is a top view of the device of FIG. 1;

FIG. 3 is a perspective view in partial section of the device of FIG. 1;

FIG. 4 is an exploded partial section view of the device of FIG. 1;

FIG. 5 is a perspective view of a realization variant of the device for separating gas from a vector fluid of FIG. 1;

FIG. 6 is a perspective view of another realization variant of the device for separating gas from a vector fluid of FIG. 1.

FIG. 7 is another partial section view of the device of FIG. 1.

### DETAILED DESCRIPTION OF THE INVENTION

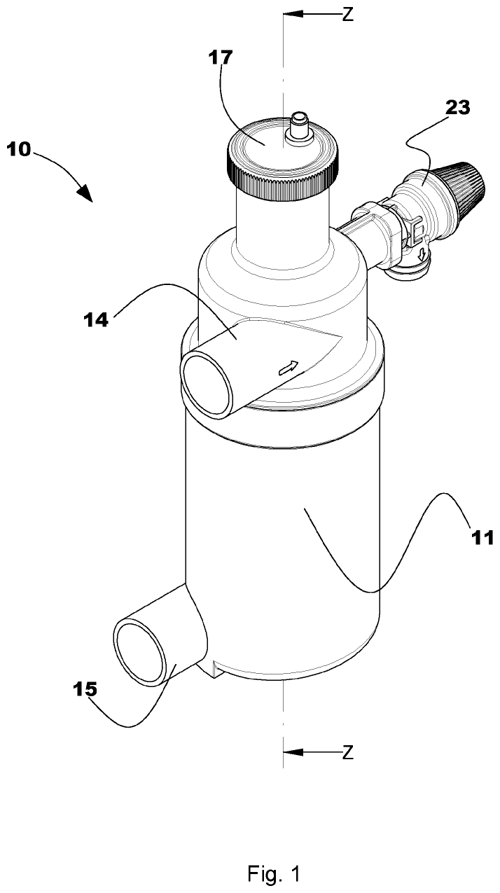

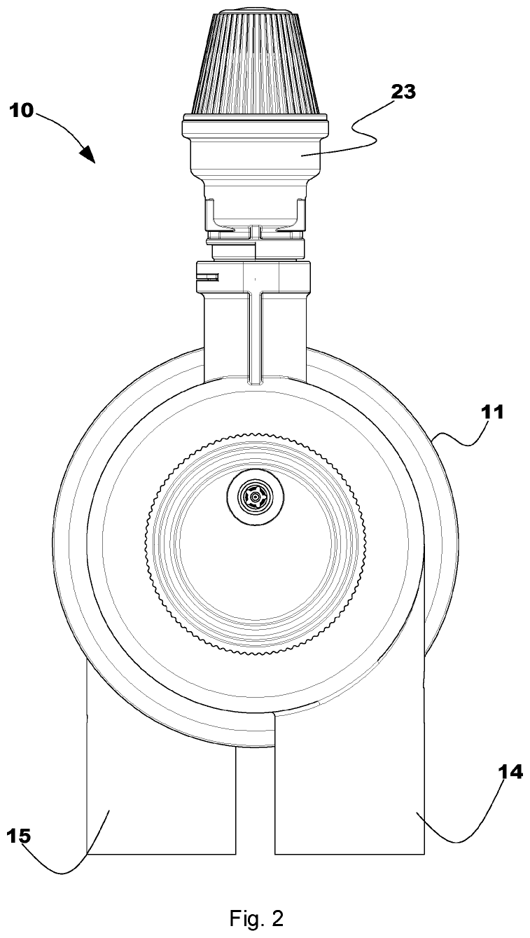

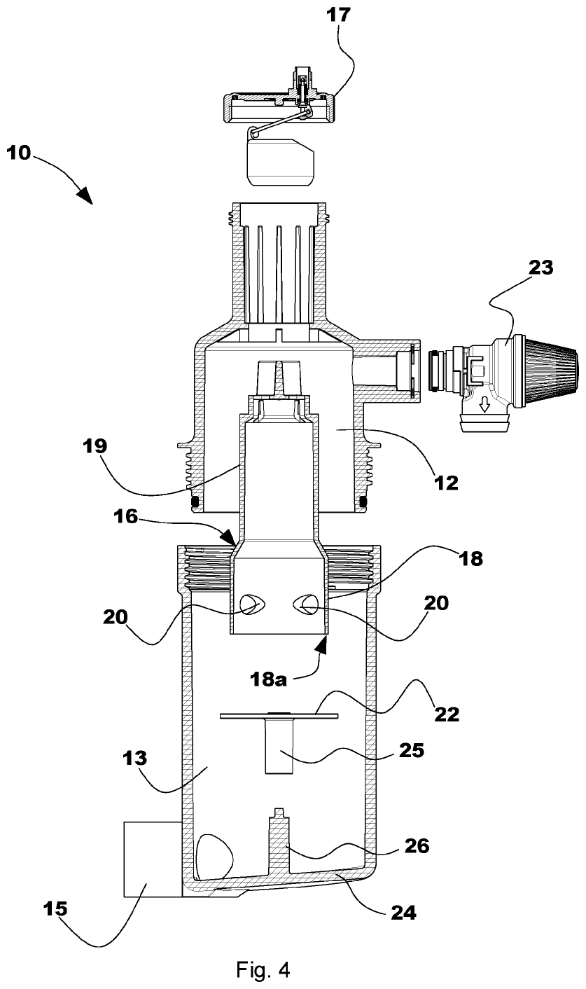

The general features of the present invention will be illustrated below through the exemplifying and non-limiting embodiment of FIGS. 1-4.

The illustrated device for separating gas from a vector fluid, indicated generically by 10, is intended to be installed in a circuit of a thermal system.

The device 10 has a body 11 inside which there is a cylindrical chamber, formed (with reference to the operating position) by an upper section 12, provided with a vector fluid inlet 14 connected, during use, to an inlet pipe (not shown), and a lower section 13, provided with a vector fluid outlet 15 connected, in use, to an outlet pipe (not shown). These sections 12 and 13 are arranged along a same axis Z. In particular, the inner diameter of the upper section 12 is smaller than the inner diameter of the lower section 13.

As clearly visible in the figures, the inlet 14 is arranged in the upper part of the body 11 of the device 10 whereas the outlet 15 is arranged in the lower part of the body 11 of the device 10 at the bottom 24 of the lower section 13.

Both the inlet 14 and the outlet 15 of the vector fluid are arranged offset with respect to the Z axis and, in particular, are positioned substantially tangentially to the sections 12, 13 of the cylindrical chamber of the body 11.

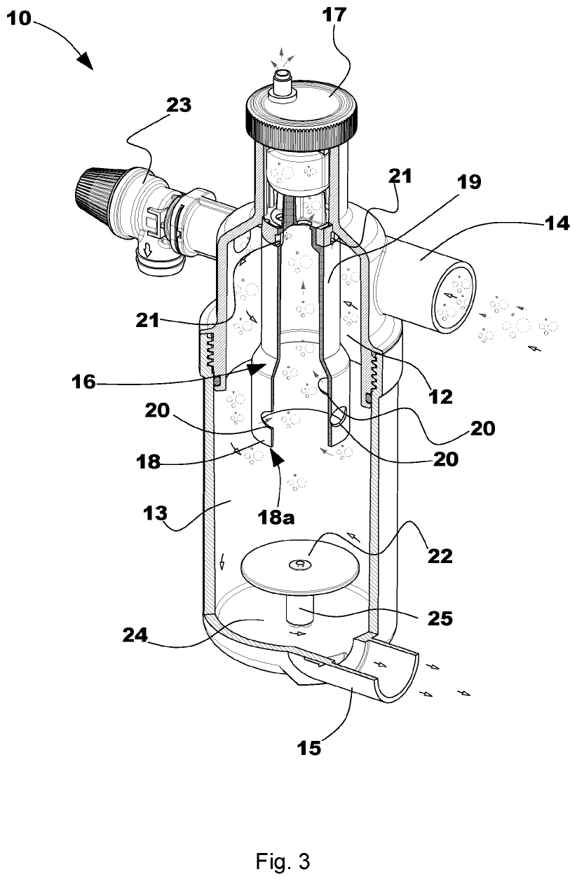

Inside the upper section 12, as shown in FIGS. 3,4, a gas collecting tube 16 is located coaxially, communicating upperly with an automatic gas vent valve 17 of known type and lowerly with the lower section 13.

The tube 16, in detail, has an end portion 18, at the lower section 13, having a greater diameter than that of the remaining portion 19 of the tube 16 and gradually connected to the latter. The end portion 18 of the tube 16 has a series of through openings 20 in the shape of circular holes, arranged, in particular, in an annular manner. The tube 16 is further provided, at the remaining portion 19, with upper passages 21 between the outside and the inside of the tube itself to convey the gas which accumulates in the upper part of the upper section 12 to the vent valve 17.

Otherwise, the lower section 13 has centrally, near and upstream of the outlet 15 and in a higher position with respect to this outlet 15, an intercepting disc 22 provided with a stem 25 fixed to a central pin 26 which is in turn fixed to the bottom 24 of the lower section 13.

The edge 18A of the end portion 18 of the tube 16 is spaced away from the intercepting disc 22 according to a predetermined distance H.

For a high efficiency of the device, the aforesaid distance H is between 0.5 cm and 15 cm.

Again, for high efficiency of the device, the ratio between the diameter D1 of the inner cylindrical chamber of the body 11 at the intercepting disc 22 and the diameter D2 of the intercepting disc 22 must not be greater than 5.

Lastly, the body 11 has a safety valve 23, located in the upper section 12, to discharge the vector fluid in the event of overpressure of the vector fluid itself inside the device 10.

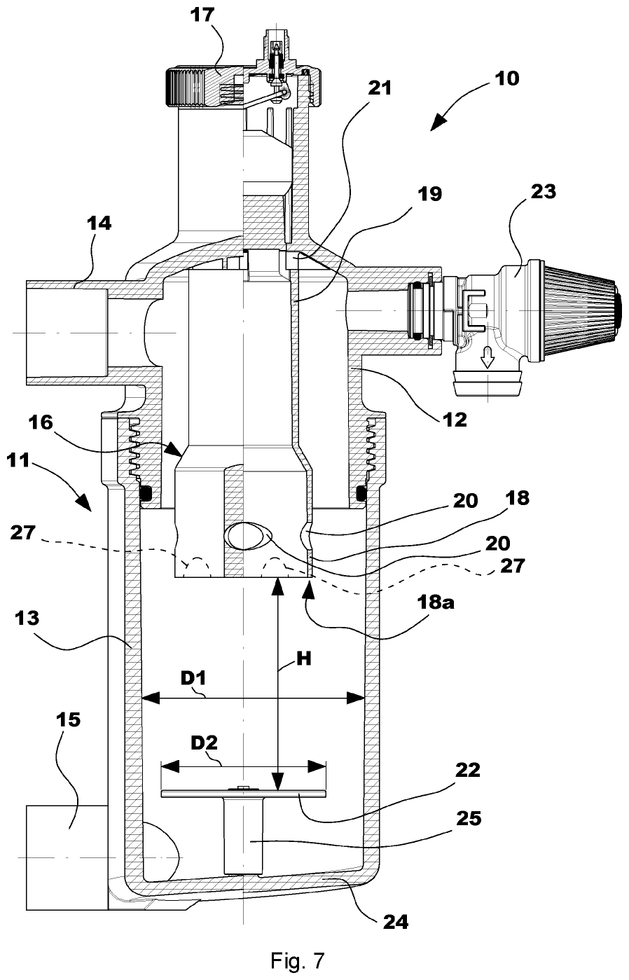

Recesses 27 indicated in broken lines in FIG. 7 can be made along the edge 18A of the end portion 18 of the tube 16.

The operation of the device 10 is schematized in FIG. 3.

The vector fluid enters the device 10 through the inlet 14. Given the offset position of this inlet 14, the vector fluid takes on a swirling motion inside the sections 12, 13 which envelops the tube 16.

In particular, the swirling motion of the vector fluid, containing gas, determines the separation of the gas from the vector fluid and the confinement of the gas, in the form of bubbles, in a central area of the vortex.

It occurs that the gas bubbles thus produced enter the gas collecting tube 16 both through the openings 20 present on the end portion 18 and through the end portion 18 itself, and through the recesses 27 where provided. In this way, a great amount of gas rises to the vent valve 17, being protected inside the tube 16 from the flow of the vector fluid outside the tube 16. Further, as previously mentioned, also the gas bubbles which accumulate in the upper part of the upper section 12 are conveyed to the vent valve 17 thanks to the passages 21 with which the remaining portion 19 of the tube 16 is provided, further facilitating the rise of the gas to the vent valve 17.

Between the edge 18A of the tube 16 and the intercepting disc 22, a central part of the vector fluid in a swirling motion is formed having a high amount of gas. The intercepting disc 22 prevents this central part of the vector fluid with a high amount of gas from continuing towards the outlet 15 and therefore the gas bubbles of this central part of vector fluid can rise inside the tube 16 towards the gas vent valve 17.

From the outlet 15 vector fluid thus flows out, which is substantially free of gas or with a minimum, not significant amount of gas.

Thanks to the aforesaid features, the device 10 has a high gas evacuation capacity and, in this way, can evacuate all or almost all the amount of gas passing through the circuit of the thermal system in a single passage although maintaining small dimensions, so as to make the device 10 easy to assemble with the piping of a circuit of a thermal system.

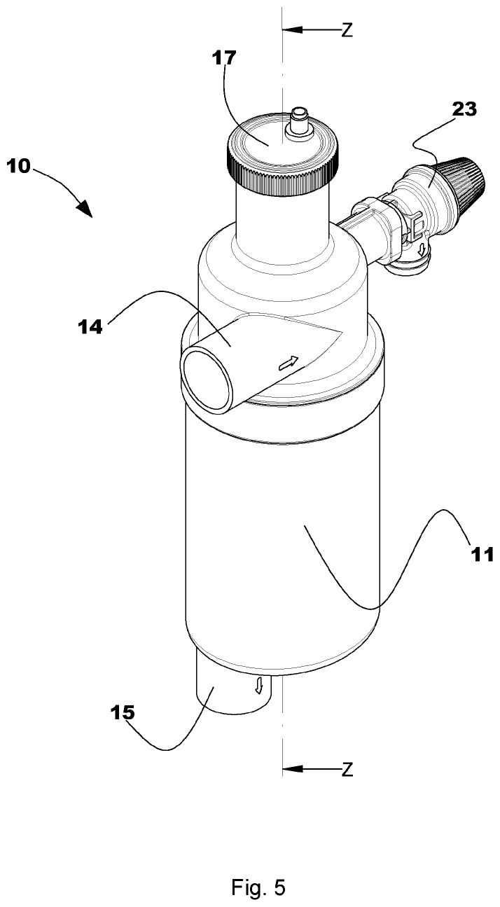

In FIG. 5, the outlet 15 of the device 10, instead of being arranged in an offset manner with respect to the Z axis and tangential with respect to the cylindrical sections 12, 13, is arranged in the direction of the Z axis in an offset manner with respect to the same axis.

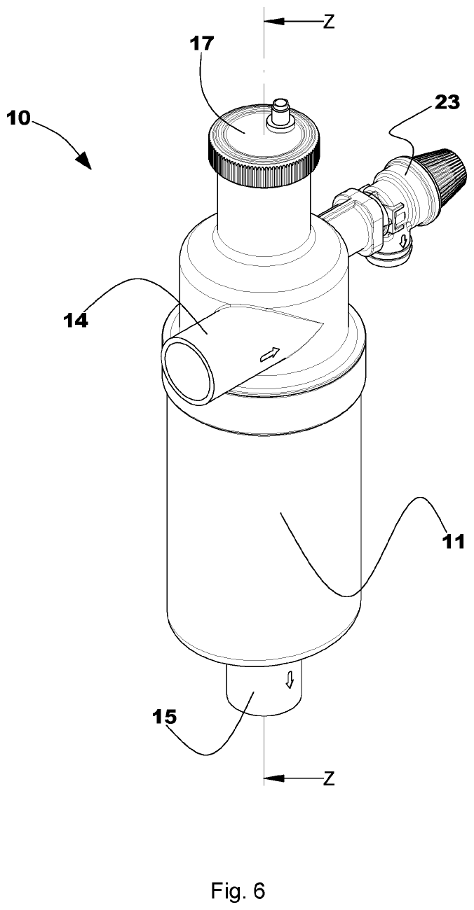

In FIG. 6, on the other hand, the outlet 15 is arranged along the Z axis coaxially with respect to the same axis.

Configuration variants and dimensional ratio variants of the components of the illustrated device are possible.

The shape and number of the through openings of the tube can be different from those illustrated. The openings can also be formed in other sections of the tube and not only in the terminal section. The tube can be of the same diameter along its entire length.

The upper and lower sections of the cylindrical chamber can have the same diameter or the upper section can have a greater diameter than the diameter of the lower section.

The intercepting disc can be replaced by any element of any shape having an equivalent function.

The safety valve can alternatively be placed in the lower section of the device body.

1. Device for separating gas from a vector fluid in a circuit of a thermal system, including a body having a cylindrical chamber inside including an upper section and a lower section arranged along a same axis and being provided with an inlet of a vector fluid at said upper section and with an outlet of a vector fluid at said lower section, wherein at least the inlet of the vector fluid is arranged offset with respect to the axis of said sections so that the vector fluid forms a swirling motion inside said sections, wherein in said upper section a gas collecting tube is located coaxially, communicating upperly with an automatic gas vent valve and lowerly with said lower section, wherein outside said tube and around said tube a swirling motion of the vector fluid is formed and inside said tube gas bubbles rise to the gas vent valve for discharging the collected gas, wherein said lower section has centrally, near and upstream of the outlet, an intercepting disc which is spaced away from the lower edge of said tube according to a predetermined distance and which prevents the central part of the vector fluid in a swirling motion that forms between the aforesaid edge of said tube and said disc to flow into the outlet area.

2. Separating device according to claim 1, wherein said gas collecting tube has a series of through openings which put the outside of the tube in communication with the inside of the tube for the passage of the gas bubbles from the outside to the inside of said tube.

3. Separating device according to claim 2, wherein said openings are formed in the end portion of said tube at said lower section.

4. Separating device according to claim 2, wherein said through openings are arranged in an annular manner.

5. Separating device according to claim 1, wherein a series of recesses is formed along the aforesaid lower edge of said tube.

6. Separating device according to claim 1, wherein the aforesaid predetermined distance between said lower edge of said tube and said intercepting disc is between 0.5 cm and 15 cm.

7. Separating device according to claim 1, wherein the ratio between the diameter of said inner cylindrical chamber of the body at said intercepting disc and the diameter of said intercepting disc must not be higher than 5.

8. Separating device according to claim 1, wherein also said outlet of the vector fluid is arranged offset with respect to the axis of said sections.

9. Separating device according to claim 8, wherein the inlet and the outlet of the vector fluid are arranged substantially tangential to said sections.

10. Separating device according to claim 1, wherein said outlet of the vector fluid is arranged in the direction of the axis in an offset manner with respect to the axis itself.

11. Separating device according to claim 1, wherein said outlet of the vector fluid is arranged along the axis coaxially with the axis itself.

12. Separating device according to claim 1, wherein said gas collecting tube has an increase in diameter in the end portion at said lower section with respect to the diameter of the remaining portion of said tube.

13. Separating device according to claim 12, wherein in said tube said end portion of greater diameter and said remaining portion of smaller diameter are gradually connected.

14. Separating device according to claim 12, wherein said tube has, at said remaining portion, one or more passages for conveying the gas which accumulates in the upper part of said upper section towards the gas vent valve.

15. Separating device according to claim 1, wherein the inner diameter of said upper section is smaller than the inner diameter of said lower section.

16. Separating device according to claim 1, wherein a safety valve is located in said body for discharging the vector fluid in the event of overpressure of the vector fluid.
